(19) United States
(12) Patent Application Publication
(10) Pub. No.: US 2026/0314534 A1
(43) Pub. Date: Oct. 15, 2026

(54) GARDEN TOOLS TRAVEL DRIVING MECHANISM AND THE GARDEN TOOLS WITH SUCH A MECHANISM

(71) Applicant: Greenworks (Jiangsu) Co. Ltd., Changzhou (CN)

(72) Inventors: Qunli Wei, Changzhou (CN); Dongdong Shi, Changzhou (CN)

(21) Appl. No.: 19/716,686

(22) Filed: Jun. 23, 2026

Related U.S. Application Data
(63) Continuation of application No. 18/558,621, filed on Nov. 15, 2022.

(30) Foreign Application Priority Data
Nov. 17, 2021 (CN) 2021228253815

(51) Int. Cl. A01D 69/02; A01D 69/06; A01D 69/10; B60K 7/00; B60K 17/04; B60L 50/60; B60T 1/06; B60T 13/74; F16H 1/46

(52) U.S. Cl. CPC A01D 69/02; A01D 69/06; A01D 69/10; B60K 7/0007; B60K 17/046; B60L 50/60; B60T 1/065; B60T 13/741; F16H 1/46; B60K 2007/0092

(57) ABSTRACT

A garden tool includes: a body; a pair of traveling wheels disposed on opposite sides of the body; a driving motor secured to the body; and a planetary speed reducer coupled between the driving motor and the traveling wheels, the planetary speed reducer includes a mandrel; a first sun gear; a first planet wheel bracket supporting a first plurality of planet wheels engaged with the first sun gear; a second sun gear fixed relative to the first planet wheel bracket; a second planet wheel bracket fixed relative to the driving motor; and a second plurality of planet wheels rotatably supported by the second planet wheel bracket and engaged with the second sun gear, the traveling wheels are fixed to a rotation support having a first inner gear ring engaged with the first plurality of planet wheels and a second inner gear ring engaged with the second plurality of planet wheels.

### BACKGROUND OF THE INVENTION

This invention relates to the technical field of garden tools, and particularly relates to a garden tool walking driving mechanism and a garden tool.

### BACKGROUND

The garden tool sometimes needs to pass through the fence during working, and the width of the fence door is limited, so the design width of the garden tool needs to be controlled within a certain range. The walking driving mode of the electrically-driven mower in the current market is mainly a mode of a parallel shaft gear box and a motor, and the structure has the problems that the occupied space is large, and other materials are inconvenient to arrange; the prior art also has the driving mode of directly driving the wheels by adopting the motor, saves the speed reducer to save space, but the motor is limited by the size of the wheels, has limited power and is difficult to meet the power requirement of garden tools.

### SUMMARY OF THE INVENTION

In view of the above-mentioned disadvantages of the prior art, the present invention provides a garden tool walking drive mechanism and a garden tool, which can reduce the lateral size of the drive mechanism while satisfying the power requirement.

To achieve the above and other related objects, the present invention provides a garden tool including a body; a pair of traveling wheels disposed on opposite sides of the body; a driving motor secured to the body; and a planetary speed reducer coupled between the driving motor and the traveling wheels, wherein the planetary speed reducer includes a mandrel extending along an axial direction of the traveling wheels; a first sun gear fixed relative to the mandrel; a first planet wheel bracket rotatably supported relative to the mandrel and supporting a first plurality of planet wheels engaged with the first sun gear; a second sun gear fixed relative to the first planet wheel bracket; a second planet wheel bracket fixed relative to the driving motor; and a second plurality of planet wheels rotatably supported by the second planet wheel bracket and engaged with the second sun gear, wherein the traveling wheels are fixed to a rotation support, the rotation support comprises a first inner gear ring engaged with the first plurality of planet wheels and a second inner gear ring engaged with the second plurality of planet wheels, and the first inner gear ring and the second inner gear ring are axially spaced from each other.

According to one aspect of the technology described herein, the mandrel is connected to a main shaft of the driving motor in a synchronous rotational manner.

According to another aspect of the technology described herein, the mandrel is spline-coupled to the main shaft of the driving motor.

According to another aspect of the technology described herein, the rotation support comprises a cylindrical side wall and an end cover.

According to another aspect of the technology described herein, the cylindrical side wall is rotatably connected to the second planet wheel bracket through a bearing.

According to another aspect of the technology described herein, the end cover is secured to an end of the cylindrical side wall opposite the driving motor.

According to another aspect of the technology described herein, a first end of the mandrel is rotatably supported by the end cover through a bearing.

According to another aspect of the technology described herein, a second end of the mandrel is rotatably supported by the second planet wheel bracket through a bearing.

According to another aspect of the technology described herein, further including a seal disposed between the cylindrical side wall and a motor housing of the driving motor.

According to another aspect of the technology described herein, the seal comprises a sliding seal.

According to another aspect of the technology described herein, each of the traveling wheels comprises a hub and a tire.

According to another aspect of the technology described herein, the hub of each traveling wheel comprises an inwardly extending flange fixed to the rotation support.

According to another aspect of the technology described herein, the inwardly extending flange is detachably secured to the rotation support.

According to another aspect of the technology described herein, further including a brake disposed on a side of the driving motor opposite the planetary speed reducer.

According to another aspect of the technology described herein, the brake comprises an electromagnetic brake.

According to another aspect of the technology described herein, a garden tool includes a body; a pair of traveling wheels disposed on opposite sides of the body and defining an axial space therebetween; a driving motor mounted to the body; and a reduction transmission assembly operatively coupling the driving motor to the traveling wheels, wherein at least a portion of the driving motor extends into the axial space defined between the traveling wheels, and wherein at least a portion of the reduction transmission assembly is disposed within the axial space defined between the traveling wheels.

According to another aspect of the technology described herein, 17. The garden tool of claim 16, wherein the axial space extends along a rotational axis of the traveling wheels.

According to another aspect of the technology described herein, the reduction transmission assembly comprises a planetary reduction assembly.

According to another aspect of the technology described herein, the planetary reduction assembly comprises a plurality of planetary reduction stages arranged along an axial direction of the traveling wheels.

According to another aspect of the technology described herein, the driving motor and the reduction transmission assembly are arranged substantially coaxially.

According to another aspect of the technology described herein, each of the traveling wheels is secured to a respective rotation support configured to rotate relative to the body

According to another aspect of the technology described herein, each rotation support comprises an internal gear structure engaged with the reduction transmission assembly.

According to another aspect of the technology described herein, the internal gear structure of each rotation support comprises a first internal gear ring and a second internal gear ring spaced apart from each other along an axial direction.

According to another aspect of the technology described herein, the reduction transmission assembly comprises a first reduction stage and a second reduction stage configured to sequentially reduce a rotational speed output from the driving motor.

According to another aspect of the technology described herein, further including a brake disposed on a side of the driving motor opposite the reduction transmission assembly.

According to another aspect of the technology described herein, the brake comprises an electromagnetic brake.

According to another aspect of the technology described herein, the electromagnetic brake is configured to selectively prevent rotation of the corresponding traveling wheel.

According to another aspect of the technology described herein, the driving motor, the reduction transmission assembly, and the traveling wheels collectively form a wheel-drive module configured for installation on the body as a unit.

According to another aspect of the technology described herein, the wheel-drive module further comprises a housing supporting both the driving motor and the reduction transmission assembly.

According to another aspect of the technology described herein, further including a mandrel extending through at least a portion of the reduction transmission assembly.

According to another aspect of the technology described herein, the mandrel is rotatably supported at opposite axial ends thereof by bearing assemblies arranged on opposite sides of the reduction transmission assembly.

### BRIEF DESCRIPTION OF THE DRAWINGS

The invention may be best understood by reference to the following description taken in conjunction with the accompanying drawing figures in which:

FIG. 1 is a schematic perspective view of a lawn mower provided in accordance with an embodiment of the present invention;

FIG. 2 is a schematic perspective view of a lawn mower according to another embodiment of the present invention;

FIG. 3 is an exploded view of a travel drive mechanism provided by an embodiment of the present invention;

FIG. 4 is an exploded view of the internal structure of the decelerator provided in the embodiment of the present invention;

FIG. 5 is an exploded view of a second planet carrier and second planet provided by an embodiment of the utility model;

FIG. 6 is a perspective view of a rotating bracket provided by an embodiment of the present invention;

FIG. 7 is a cross-sectional view of a travel drive mechanism provided by an embodiment of the present invention;

FIG. 8 is a schematic diagram of a retarder provided by an embodiment of the present invention;

FIG. 9 is a rear view of a lawnmower provided in accordance with an embodiment of the present invention.

### DETAILED DESCRIPTION OF THE INVENTION

The embodiments of the present invention are described below with reference to specific embodiments, and other advantages and effects of the present invention will be easily understood by those skilled in the art from the disclosure of the present specification. The utility model is capable of other and different embodiments and of being practiced or of being carried out in various ways, and its several details are capable of modification in various respects, all without departing from the spirit and scope of the present invention. It is to be noted that the features in the following embodiments and examples may be combined with each other without conflict.

It should be noted that the drawings provided in the following embodiments are only for illustrating the basic idea of the present invention, and the drawings only show the components related to the present invention rather than the number, shape and size of the components in actual implementation, and the type, quantity and proportion of the components in actual implementation may be changed freely, and the layout of the components may be more complicated.

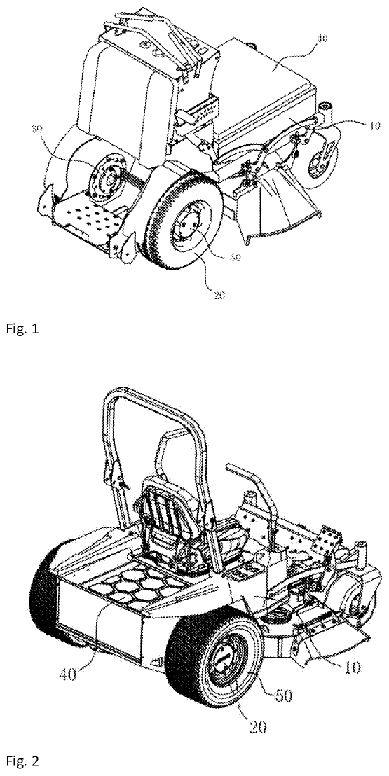

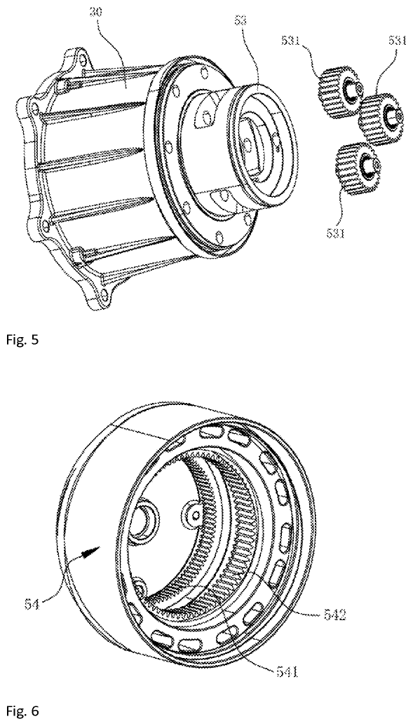

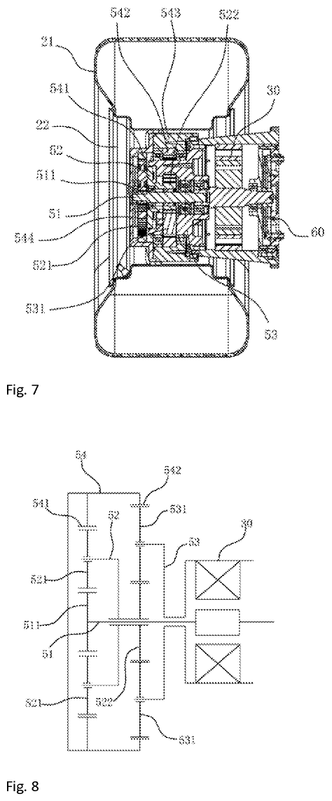

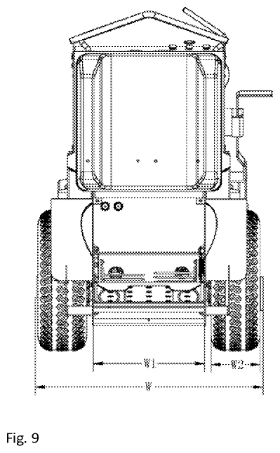

Referring to FIG. 1-6, the present invention is described in detail with reference to the application of a travel drive mechanism in a lawn mower. It should be understood that the embodiments of the present invention only illustrate some application scenarios of the walking driving mechanism, and actually, the walking driving mechanism of the present invention can also be applied to snow plows, floor sweepers, hedge trimmers, and other garden tools.

Referring to FIG. 1-6, a lawn mower includes a main body 10, road wheels 20, a driving motor 30, a power battery 40, a decelerator 50, and necessary mowing mechanisms, a control mechanism, a control module, etc.

Referring to FIG. 1 to 6, in the illustrated embodiment of the present invention, the main body 10 is a standing mower main body 10, i.e., an operator stands on the mower to perform a mowing operation, and it is understood that the walk driving mechanism of the present invention can be applied to other types of mowers such as seat mowers and walk-behind mowers.

Referring to FIGS. 1, 2, 4 and 6, the road wheels 20 are located on two sides of the body 10, and in a specific embodiment, the road wheels 20 may be, for example, pneumatic wheels composed of tires 21 and hubs 22, or integral wheels made of high molecular polymers, and the structure of the wheels is not limited to a certain form, however, it is required that the wheel center has a cavity capable of accommodating the speed reducer 50 and even the driving motor 30.

Referring to FIG. 2-5, the driving motor 30 is fixedly connected to the body 10; it is understood that the driving motor 30 of the present invention is not only used as a driving element, but also used as a supporting structure for connecting the road wheels 20 and the body 10, and therefore, the housing of the driving motor 30 should have sufficient structural strength, and for example, cast iron, cast aluminum, etc. can be used as the housing material of the driving motor 30.

Referring to FIG. 1 to 6, a power input end of the speed reducer 50 is connected to the driving motor 30, a power output end of the speed reducer 50 is connected to the traveling wheel 20, and the speed reducer 50 is disposed in an axial space in the center of the traveling wheel 20, so that it can be understood that the speed reducer 50 can increase an output torque of the driving motor 30, thereby reducing a power and a size of the driving motor 30 on the premise of ensuring sufficient power, and meanwhile, the speed reducer 50 is disposed in the central axial space of the traveling wheel 20, and the speed reducer 50 is used as a support shaft of the traveling wheel 20, thereby improving a space utilization rate, reducing an overall transverse width of the mower, and enabling the mower to have better motion flexibility on the premise of meeting a power design requirement.

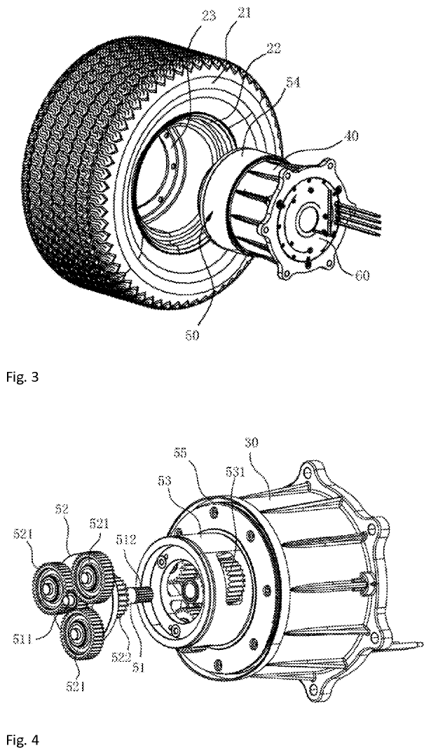

Referring to FIG. 3-5, the speed reducer 50 is a planetary speed reducer, and the planetary speed reducer has the characteristics that a larger speed reduction transmission ratio can be generated with a smaller axial size, and the axial length of the planetary speed reducer can be even smaller than the width of the road wheel 20, so that the speed reducer 50 can be completely hidden in the road wheel 20, and the transverse space utilization rate of the mower can be greatly improved.

Referring to FIG. 3-5, in a further embodiment of the present invention, the reducer 50 includes a spindle 51, a first planet carrier 52, a second planet carrier 53, and a rotating carrier 54. The spindle 51 is arranged at the center of the travelling wheel 20 along the axial direction of the travelling wheel 20, a first sun gear 511 is arranged on the spindle 51, and the first sun gear 511 is coaxially and fixedly connected with the spindle 51. The first planet wheel bracket 52 is rotationally connected with the mandrel 51, a plurality of first planet wheels 521 and a plurality of second sun wheels 522 are arranged on the first planet wheel bracket 52, the first planet wheels 521 are rotationally connected with the first planet wheel bracket 52, the first planet wheels 521 are meshed with the first sun wheel 511, and the second sun wheels 522 are coaxially and fixedly connected with the first planet wheel bracket 52; the second planet wheel carrier 53 is fixedly arranged relative to the housing of the driving motor 30, a plurality of second planet wheels 531 are rotatably arranged on the second planet wheel carrier 53, and the second planet wheels 531 are meshed with the second sun gear 522; the rotating bracket 54 is fixedly connected with the traveling wheel 20, a first inner gear ring 541 and a second inner gear ring 542 are arranged on the rotating bracket 54, the first inner gear ring 541 and the second inner gear ring 542 are fixedly connected with the rotating bracket 54 through interference fit or fixed pins, bolts and the like, so that the rotating bracket 54 is driven to rotate, the first inner gear ring 541 and the second inner gear ring 542 are arranged at intervals along the axial direction, the first inner gear ring 541 is meshed with the first planet wheel 521, and the second inner gear ring 542 is meshed with the second planet wheel 531.

It can be understood that, in the embodiment of the present invention, the speed reducer 50 is different from a conventional planetary speed reducer, and the present invention provides two sets of planetary wheel mechanisms, wherein the inner gear rings (i.e. the first inner gear ring 541 and the second inner gear ring 542) of the two sets of planetary wheel mechanisms are fixedly connected to the rotating bracket 54, so that the rotating bracket 54 can be driven from two ends thereof, and power distribution is more uniform; in addition, the differential cooperation between the two groups of planet wheels realizes two-stage speed reduction from the driving motor 30 to the road wheels 20, the transmission ratio is larger, and the torque lifting is more obvious.

Referring to FIGS. 3 and 4, the spindle 51 is connected to the main shaft of the driving motor 30 by a spline 512 for synchronous rotation. The rotating bracket 54 includes a cylindrical sidewall 543 and an end cover 544, the cylindrical sidewall 543 is rotatably connected to the second planet carrier 53 through a bearing, and the end cover 544 is fixed to one end of the cylindrical sidewall 543, which is far away from the driving motor 30. One end of the spindle 51 is rotatably connected to the end cover 544 through a bearing, and the other end of the spindle is rotatably connected to the second planet carrier 53 through a bearing. In the embodiment of the present invention, the second planet carrier 53 and the housing of the driving motor 30 can be integrally formed, and both are the same component, for example, a protruding structure is directly arranged at the front end of the housing of the driving motor 30, and the second planet 531 is directly mounted on the protruding structure, so that the assembly process can be simplified, the material can be saved, the cost can be reduced, the assembly structure can be simpler, and the second planet carrier 53 can be fixed as long as the housing of the driving motor 30 is fixed on the vehicle body; in addition, the second planet wheel carrier 53 and the housing of the driving motor 30 can be formed separately and then connected into a whole by welding, riveting, bolting and other means.

Referring to FIG. 3, a sliding seal ring 55 is disposed between the cylindrical sidewall and the housing of the driving motor 30, and it can be understood that the cylindrical sidewall, the end cap and the housing of the driving motor 30 can be enclosed to form a closed gear box, so that lubricant can be injected to improve the transmission efficiency of the reducer 50.

Referring to FIG. 2, a flange 23 is disposed on an inner annular surface of the hub 22, and the flange 23 is detachably and fixedly connected to the rotating bracket 54. Although the utility model adopts a new transmission structure, the installation mode of the walking wheels 20 is basically the same as that of common wheels, thus being convenient for disassembly, assembly and maintenance.

Referring to FIG. 4, at least a partial region of the driving motor 30 protrudes into an axial space in the center of the road wheel 20. The driving mechanism further includes a brake 60, and the brake 60 is disposed on a side of the driving motor 30 opposite to the speed reducer 50. The brake 60 is an electromagnetic brake 60, and the brake 60 includes a dynamic friction plate which is synchronously connected with the main shaft of the driving motor 30 in a rotating manner, a fixed friction plate which is fixedly connected with the outer shell of the driving motor 30 relatively, and an electromagnetic driver which is used for driving the dynamic friction plate to be close to or far away from the fixed friction plate. The utility model adopts the electromagnetic brake 60 for braking, has smaller axial size and can further save the transverse space of the mower.

In conclusion, the speed reducer 50 can increase the output torque of the driving motor 30, so that the power and the size of the driving motor 30 can be reduced on the premise of ensuring sufficient power, meanwhile, the speed reducer 50 is arranged in the central axial space of the travelling wheel 20, and the speed reducer 50 is used as a supporting shaft of the travelling wheel 20, so that the space utilization rate is improved, the overall transverse width of the mower is reduced, and the mower has better motion flexibility on the premise of meeting the power design requirement. The planetary reducer can generate a larger reduction transmission ratio with a smaller axial size, and the axial length of the planetary reducer can even be smaller than the width of the travelling wheel 20, so that the reducer 50 can be completely hidden in the travelling wheel 20, the transverse space utilization rate of the mower is greatly improved, as shown in FIG. 1, for a standing mower, the interference between the driving motor 30 and the reducer 50 is avoided, the pedal can extend forwards, the standing space of an operator is increased, and when a user stands on the pedal, the gravity center of a human body is positioned on the center of the rotating axis of the travelling wheel 20 of the standing mower, so that when the standing mower turns in place, the rotating radius is avoided, the centrifugal force is avoided, and the human body is not in danger of being thrown away; in addition, the pedals move forward, the gravity center of the human body also moves forward correspondingly, and the stand mower can be safer and is not easy to overturn no matter climbing or passing through a hollow ground; as shown in FIG. 2, for the riding mower, the power battery 40 may be installed to be lowered, the center of gravity of the power battery 40 may be lowered, the stability of the vehicle body may be improved, and after the lowered installation, one end of the power battery 40 may extend forward to below the seat of the riding mower. The utility model is provided with two groups of planetary gear mechanisms, and the inner gear rings of the two groups of planetary gear mechanisms are fixedly connected with the rotating bracket 54, so that the two groups of planetary gear mechanisms can be driven from the two ends of the rotating bracket 54, and the power distribution is more uniform; in addition, the differential cooperation between the two groups of planet wheels realizes two-stage speed reduction from the driving motor 30 to the road wheels 20, the transmission ratio is larger, and the torque lifting is more obvious.

Referring to FIG. 6, the overall weight of the mower provided by the utility model can be up to 550 kg at most, and the width W2 and the size W2 of the selected tires are not more than 180 mm in consideration of the load of the tires. The width W of the whole machine is not more than 33 inches (838.2 mm), the width W1 of the position where a person stands is at least more than 400 mm, and customers can not feel crowded at the standing position on the standing pedal.

The foregoing embodiments are merely illustrative of the principles and utilities of the present invention and are not intended to limit the utility model. Any person skilled in the art can modify or change the above-mentioned embodiments without departing from the spirit and scope of the present invention. Accordingly, it is intended that all equivalent modifications or changes which can be made by those skilled in the art without departing from the spirit and technical spirit of the present invention be covered by the claims of the present invention.

In the description herein, numerous specific details are provided, such as examples of components and/or methods, to provide a thorough understanding of embodiments of the utility model. One skilled in the relevant art will recognize, however, that an embodiment of the utility model can be practiced without one or more of the specific details, or with other apparatus, systems, assemblies, methods, components, materials, parts, and/or the like. In other instances, well-known structures, materials, or operations are not shown or described in detail to avoid obscuring aspects of embodiments of the utility model.

Reference throughout this specification to “one embodiment,” “an embodiment,” or “a specific embodiment” means that a particular feature, structure, or characteristic described in connection with the embodiment is included in at least one embodiment, and not necessarily in all embodiments, of the present invention. Thus, appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the utility model described and illustrated herein are possible in light of the teachings herein and are to be considered as part of the spirit and scope of the present invention.

It will also be appreciated that one or more of the elements shown in the figures can also be implemented in a more separated or integrated manner, or even removed for inoperability in some circumstances or provided for usefulness in accordance with a particular application.

Additionally, any reference arrows in the drawings/figures should be considered only as exemplary, and not limiting, unless otherwise expressly specified.

Further, as used herein, the term “or” is generally intended to mean “and/or” unless otherwise indicated. Combinations of components or steps will also be considered as being noted where terminology is foreseen as rendering the ability to separate or combine is unclear.

As used in the description herein and throughout the claims that follow, “a,” “an,” and “the” include plural references unless otherwise indicated. Also, as used in the description herein and throughout the claims that follow, the meaning of “in . . . ” includes “in . . . ” and “on . . . ” unless otherwise indicated.

The above description of illustrated embodiments of the utility model, including what is described in the abstract of the specification, is not intended to be exhaustive or to limit the utility model to the precise forms disclosed herein. While specific embodiments of, and examples for, the utility model are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

The systems and methods have been described herein in general terms as the details aid in understanding the utility model. Furthermore, various specific details have been given to provide a general understanding of the embodiments of the utility model. One skilled in the relevant art will recognize, however, that an embodiment of the utility model can be practiced without one or more of the specific details, or with other apparatus, systems, assemblies, methods, components, materials, parts, and/or the like. In other instances, well-known structures, materials, and/or operations are not specifically shown or described in detail to avoid obscuring aspects of embodiments of the utility model.

Thus, although the present invention has been described herein with reference to particular embodiments thereof, a latitude of modification, various changes and substitutions are intended in the foregoing disclosures, and it will be appreciated that in some instances some features of the utility model will be employed without a corresponding use of other features without departing from the scope and spirit of the utility model as set forth.

Thus, many modifications may be made to adapt a particular situation or material to the essential scope and spirit of the present invention. It is intended that the utility model not be limited to the particular terms used in following claims and/or to the particular embodiment disclosed as the best mode contemplated for carrying out this invention, but that the utility model will include any and all embodiments and equivalents falling within the scope of the appended claims. Accordingly, the scope of the utility model is to be determined solely by the appended claims.

What is claimed is:

1. A garden tool, comprising:
a body;
a pair of traveling wheels disposed on opposite sides of the body;
a driving motor secured to the body; and
a planetary speed reducer coupled between the driving motor and the traveling wheels, wherein the planetary speed reducer comprises:
a mandrel extending along an axial direction of the traveling wheels;
a first sun gear fixed relative to the mandrel;
a first planet wheel bracket rotatably supported relative to the mandrel and supporting a first plurality of planet wheels engaged with the first sun gear;
a second sun gear fixed relative to the first planet wheel bracket;
a second planet wheel bracket fixed relative to the driving motor; and
a second plurality of planet wheels rotatably supported by the second planet wheel bracket and engaged with the second sun gear,
wherein the traveling wheels are fixed to a rotation support, the rotation support comprises a first inner gear ring engaged with the first plurality of planet wheels and a second inner gear ring engaged with the second plurality of planet wheels, and the first inner gear ring and the second inner gear ring are axially spaced from each other.

2. The garden tool of claim 1, wherein the mandrel is connected to a main shaft of the driving motor in a synchronous rotational manner.

3. The garden tool of claim 2, wherein the mandrel is spline-coupled to the main shaft of the driving motor.

4. The garden tool of claim 1, wherein the rotation support comprises a cylindrical side wall and an end cover.

5. The garden tool of claim 4, wherein the cylindrical side wall is rotatably connected to the second planet wheel bracket through a bearing.

6. The garden tool of claim 4, wherein the end cover is secured to an end of the cylindrical side wall opposite the driving motor.

7. The garden tool of claim 4, wherein a first end of the mandrel is rotatably supported by the end cover through a bearing.

8. The garden tool of claim 7, wherein a second end of the mandrel is rotatably supported by the second planet wheel bracket through a bearing.

9. The garden tool of claim 4, further comprising a seal disposed between the cylindrical side wall and a motor housing of the driving motor.

10. The garden tool of claim 9, wherein the seal comprises a sliding seal.

11. The garden tool of claim 1, wherein each of the traveling wheels comprises a hub and a tire.

12. The garden tool of claim 11, wherein the hub of each traveling wheel comprises an inwardly extending flange fixed to the rotation support.

13. The garden tool of claim 12, wherein the inwardly extending flange is detachably secured to the rotation support.

14. The garden tool of claim 1, further comprising a brake disposed on a side of the driving motor opposite the planetary speed reducer.

15. The garden tool of claim 14, wherein the brake comprises an electromagnetic brake.

16. A garden tool, comprising:
a body;
a pair of traveling wheels disposed on opposite sides of the body and defining an axial space therebetween;
a driving motor mounted to the body; and
a reduction transmission assembly operatively coupling the driving motor to the traveling wheels,
wherein at least a portion of the driving motor extends into the axial space defined between the traveling wheels, and
wherein at least a portion of the reduction transmission assembly is disposed within the axial space defined between the traveling wheels.

17. The garden tool of claim 16, wherein the axial space extends along a rotational axis of the traveling wheels.

18. The garden tool of claim 16, wherein the reduction transmission assembly comprises a planetary reduction assembly.

19. The garden tool of claim 18, wherein the planetary reduction assembly comprises a plurality of planetary reduction stages arranged along an axial direction of the traveling wheels.

20. The garden tool of claim 16, wherein the driving motor and the reduction transmission assembly are arranged substantially coaxially.

21. The garden tool of claim 16, wherein each of the traveling wheels is secured to a respective rotation support configured to rotate relative to the body.

22. The garden tool of claim 21, wherein each rotation support comprises an internal gear structure engaged with the reduction transmission assembly.

23. The garden tool of claim 22, wherein the internal gear structure of each rotation support comprises a first internal gear ring and a second internal gear ring spaced apart from each other along an axial direction.

24. The garden tool of claim 16, wherein the reduction transmission assembly comprises a first reduction stage and a second reduction stage configured to sequentially reduce a rotational speed output from the driving motor.

25. The garden tool of claim 16, further comprising a brake disposed on a side of the driving motor opposite the reduction transmission assembly.

26. The garden tool of claim 25, wherein the brake comprises an electromagnetic brake.

27. The garden tool of claim 26, wherein the electromagnetic brake is configured to selectively prevent rotation of the corresponding traveling wheel.

28. The garden tool of claim 16, wherein the driving motor, the reduction transmission assembly, and the traveling wheels collectively form a wheel-drive module configured for installation on the body as a unit.

29. The garden tool of claim 28, wherein the wheel-drive module further comprises a housing supporting both the driving motor and the reduction transmission assembly.

30. The garden tool of claim 16, further comprising a mandrel extending through at least a portion of the reduction transmission assembly.

31. The garden tool of claim 30, wherein the mandrel is rotatably supported at opposite axial ends thereof by bearing assemblies arranged on opposite sides of the reduction transmission assembly.
